(19) United States
(12) Patent Application Publication
(10) Pub. No.: US 2026/0347219 A1
(43) Pub. Date: Nov. 5, 2026

(54) OZONE WATER DECOMPOSER

(71) Applicant: SMI Co., Ltd., Cheongju-si (KR)

(72) Inventor: Jong Man KIM, Icheon-si (KR)

(21) Appl. No.: 19/660,084

(22) Filed: Apr. 27, 2026

(30) Foreign Application Priority Data
Apr. 30, 2025 (KR) 10-2025-0056933
Apr. 30, 2025 (KR) 10-2025-0056934

(51) Int. Cl. C02F 1/32; C02F 101/10; C02F 103/34

(52) U.S. Cl. CPC C02F 1/325; C02F 2101/10; C02F 2103/346; C02F 2201/002; C02F 2201/3227; C02F 2209/003; C02F 2209/40

(57) ABSTRACT

Provided is an ozonated water decomposition apparatus of a photolysis type. The ozonated water decomposition apparatus provides an ozonated water decomposition apparatus capable of preventing a lamp protection pipe configured to accommodate a UV lamp from being etched by hydrofluoric acid (HF) contained in ozonated water, and capable of efficiently decomposing the ozonated water by allowing ultraviolet rays emitted from the UV lamp to reach, with as little loss as possible, the ozonated water flowing along an ozonated water flow pipe outside the lamp protection pipe.

### CROSS-REFERENCE TO RELATED APPLICATIONS

This application claims the priority of Korean Patent Application No. 10-2025-0056933 filed on Apr. 30, 2025 and Korean Patent Application No. 10-2025-0056934 filed on Apr. 30, 2025, in the Korean Intellectual Property Office, the disclosures of which are incorporated herein by reference.

### BACKGROUND OF THE INVENTION

### Field of the Invention

The present disclosure relates to an ozonated water decomposition apparatus capable of decomposing ozonated water, which is discarded after use in a semiconductor manufacturing process or a display manufacturing process, by photolysis and discharging the ozonated water as general water having no environmentally harmful material or having a level less than a reference value.

### Description of the Related Art

In general, a large amount of ozonated water is used to clean a semiconductor wafer or the like or remove a photoresist in a semiconductor manufacturing process or a display manufacturing process.

However, because the ozonated water contains ozone that is an environmentally harmful material, the ozonated water discarded after user in the semiconductor manufacturing process or the display manufacturing process cannot be discharged in an intact manner. The ozonated water needs to be discharged after being decomposed so that the concentration of ozone is less than a reference value (e.g., 1 ppm) that is harmless to the environment and the human body in accordance with relevant regulations.

An ozonated water decomposition apparatus is an apparatus for decomposing ozonated water discarded after use in a semiconductor manufacturing process or a display manufacturing process. There are ozonated water decomposition apparatuses of a gas-liquid separation type, a photolysis type, and a chemical type. Among the apparatuses, the photolysis type ozonated water decomposition apparatus is an apparatus for decomposing ozonated water into water (H₂O) and oxygen (O₂) by irradiating the ozonated water with ultraviolet rays.

As relevant documents of related art, there are Korean Patent No. 10-2185110 (entitled "OZONATED WATER DECOMPOSITION APPARATUS" and published on Dec. 1, 2020 and Korean Patent No. 10-1776024 (entitled "OZONE DECOMPOSITION UNIT AND SUBSTRATE PROCESSING APPARATUS INCLUDING THE SAME" and published on Sep. 7, 2017).

### SUMMARY OF THE INVENTION

An object of the present disclosure is to provide an ozonated water decomposition apparatus capable of preventing a lamp protection pipe configured to accommodate a UV lamp from being etched by hydrofluoric acid (HF) contained in ozonated water, and capable of efficiently decomposing the ozonated water by allowing ultraviolet rays emitted from the UV lamp to reach, with as little loss as possible, the ozonated water flowing along an ozonated water flow pipe outside the lamp protection pipe.

Another object of the present disclosure is to provide an ozonated water decomposition apparatus capable of improving ozonated water decomposition performance by means of a decomposition cell assembly including a plurality of decomposition cells, and capable of being implemented in a compact form by minimizing a space occupied by the decomposition cell assembly as much as possible.

Still another object of the present disclosure is to provide an ozonated water decomposition apparatus capable of efficiently reducing power consumption of a plurality of decomposition cells by controlling operations of the plurality of decomposition cells so that there is no UV lamp that is unnecessarily turned on and operated among the plurality of decomposition cells.

Yet another object of the present disclosure is to provide an ozonated water decomposition apparatus capable of accurately measuring a flow rate of introduced ozonated water or a flow rate of discharged decomposed water even in case that the flow rates are low.

The objects are achieved by an ozonated water decomposition apparatus according to an embodiment of the present disclosure, the ozonated water decomposition apparatus including: a main body casing; a decomposition cell assembly disposed in the main body casing and including a plurality of decomposition cells configured to decompose ozonated water by photolysis; an ozonated water inflow guide pipe configured to provide a flow path configured to guide ozonated water introduced from the outside to the decomposition cell assembly; and a decomposed water discharge guide pipe configured to provide a flow path guide and discharge decomposed water, which is produced by decomposing ozone by the decomposition cell assembly, to the outside from the decomposition cell assembly, in which the decomposition cell includes: an ozonated water flow pipe configured to provide a flow path along which the ozonated water flows; a UV lamp disposed in the ozonated water flow pipe and configured to emit ultraviolet rays to the ozonated water flowing along the ozonated water flow pipe; and a lamp protection pipe disposed in the ozonated water flow pipe, configured to accommodate the UV lamp, and made of a material that transmits the ultraviolet rays emitted from the UV lamp.

In particular, the decomposition cell may further include a fluorine-based ultraviolet transmission layer formed on an outer peripheral surface of the lamp protection pipe, which is in contact with the ozonated water, in order to prevent the lamp protection pipe from being etched by hydrofluoric acid (HF) contained in the ozonated water.

In particular, the fluorine-based ultraviolet transmission layer may be made of fluorinated ethylene propylene (FEP).

In particular, in order for the ultraviolet rays emitted from the UV lamp to efficiently decompose the ozonated water flowing along the ozonated water flow pipe, a distance between an outer peripheral surface of the UV lamp and an inner peripheral surface of the ozonated water flow pipe may be 10 mm or less.

In particular, the decomposition cell may be provided as a plurality of decomposition cells, and the plurality of decomposition cells may include: a first decomposition cell to which the ozonated water inflow guide pipe is connected; a second decomposition cell disposed in parallel with the first decomposition cell in a horizontal direction; a third decomposition cell disposed in parallel with the second decomposition cell in a vertical direction and disposed above the second decomposition cell; and a fourth decomposition cell disposed in parallel with the third decomposition cell in the horizontal direction, disposed above the first decomposition cell, and connected to the decomposed water discharge guide pipe.

In particular, the decomposition cell assembly may further include a first flow path connection pipe configured to provide a flow path configured to connect the first decomposition cell and the second decomposition cell, a second flow path connection pipe configured to provide a flow path configured to connect the second decomposition cell and the third decomposition cell, and a third flow path connection pipe configured to provide a flow path configured to connect the third decomposition cell and the fourth decomposition cell.

In particular, the ozonated water introduced into the decomposition cell assembly through the ozonated water inflow guide pipe may sequentially pass through the first decomposition cell, the second decomposition cell, the third decomposition cell, and the fourth decomposition cell, and the ozonated water may be discharged to the outside through the decomposed water discharge guide pipe after ozone is decomposed from the ozonated water.

In particular, the ozonated water decomposition apparatus may further include: a decomposition cell support frame disposed in the main body casing and configured to support the decomposition cell assembly to fix a position of the decomposition cell assembly, in which the decomposition cell support frame includes: a first decomposition cell support pipe configured to accommodate and support the first decomposition cell in a predetermined section in a longitudinal direction of the first decomposition cell; a second decomposition cell support pipe configured to accommodate and support the second decomposition cell in a predetermined section in a longitudinal direction of the second decomposition cell; a third decomposition cell support pipe configured to accommodate and support the third decomposition cell in a predetermined section in a longitudinal direction of the third decomposition cell; a fourth decomposition cell support pipe configured to accommodate and support the fourth decomposition cell in a predetermined section in a longitudinal direction of the fourth decomposition cell; a first fixing plate to which ends of the first to fourth decomposition cell support pipes are coupled, the first fixing plate being fixed to the main body casing; and a second fixing plate to which the other ends of the first to fourth decomposition cell support pipes are coupled, the second fixing plate being fixed to the main body casing.

In particular, the ozonated water decomposition apparatus may further include: a flowmeter installed in the decomposed water discharge guide pipe or installed in a flow path connected to the decomposed water discharge guide pipe in order to identify a flow rate of the decomposed water flowing along the decomposed water discharge guide pipe; and a controller configured to control operations of the plurality of decomposition cells based on flow rate data measured by the flowmeter.

In particular, the controller may control ON/OFF operations of the UV lamps in the plurality of decomposition cells based on flow rate data measured by the flowmeter.

In particular, the controller may increase the number of decomposition cells in which the UV lamps are in an ON state among the plurality of decomposition cells when a flow rate measured by the flowmeter increases, and the controller may decrease the number of decomposition cells in which the UV lamps are in an ON state among the plurality of decomposition cells when a flow rate measured by the flowmeter decreases.

In particular, the flowmeter may be provided as an ultrasonic flowmeter configured to measure a flow rate in a non-contact manner.

In particular, the ozonated water decomposition apparatus may further include: a flow rate measurement connection pipe configured to provide a flow path configured to connect a first point and a second point of the decomposed water discharge guide pipe, in which a part of the decomposed water flowing into the decomposed water discharge guide pipe from the decomposition cell assembly is diverged from the first point, flows along the flow rate measurement connection pipe, is merged into the decomposed water flowing along the decomposed water discharge guide pipe at the second point, and then is discharged to the outside, and in which the flowmeter is installed in the flow rate measurement connection pipe and measures a flow rate of the decomposed water flowing along the flow rate measurement connection pipe.

In particular, the flow rate measurement connection pipe may be formed to have an inner diameter smaller in size than an inner diameter of the decomposed water discharge guide pipe.

According to an ozonated water decomposition apparatus according to the embodiment of the present disclosure, it is possible to prevent the lamp protection pipe configured to accommodate the UV lamp from being etched by hydrofluoric acid (HF) contained in ozonated water and to efficiently decompose the ozonated water by allowing ultraviolet rays emitted from the UV lamp to reach, with as little loss as possible, the ozonated water flowing along the ozonated water flow pipe outside the lamp protection pipe.

According to the ozonated water decomposition apparatus according to the embodiment of the present disclosure, it is possible to improve the ozonated water decomposition performance by means of the decomposition cell assembly including the plurality of decomposition cells and to implement the ozonated water decomposition apparatus in a compact form by minimizing a space occupied by the decomposition cell assembly as much as possible.

According to the ozonated water decomposition apparatus according to the embodiment of the present disclosure, it is possible to adjust the number of UV lamps used in the plurality of decomposition cells in accordance with a flow rate of introduced ozonated water or a flow rate of discharged decomposed water, such that there is no UV lamp that is unnecessarily turned on and operated, thereby efficiently reducing power consumption of the plurality of decomposition cells.

According to the ozonated water decomposition apparatus according to the embodiment of the present disclosure, the first point and the second point of the decomposed water discharge guide pipe are connected, and the flowmeter is installed in the flow rate measurement connection pipe having a smaller inner diameter than the decomposed water discharge guide pipe, such that a flow rate of introduced ozonated water or a flow rate of discharged decomposed water may be accurately measured even in case that the flow rates are low.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a perspective view illustrating an external appearance of an ozonated water decomposition apparatus according to an embodiment of the present disclosure;

FIG. 2 is a right side view illustrating an interior of the ozonated water decomposition apparatus in FIG. 1;

FIG. 3 is a perspective view illustrating a main configuration installed in the ozonated water decomposition apparatus in FIG. 1;

FIG. 4 is a perspective view of a decomposition cell assembly in the ozonated water decomposition apparatus in FIG. 1;

FIGS. 5A and 5B are a front view and a rear view of the decomposition cell assembly illustrated in FIG. 4;

FIG. 6 is a configuration view schematically illustrating an internal structure of a decomposition cell that constitutes the decomposition cell assembly in FIG. 4;

FIG. 7 is a perspective view of a decomposition cell support frame of the ozonated water decomposition apparatus in FIG. 1; and

FIG. 8 is a block diagram schematically illustrating a control configuration of the ozonated water decomposition apparatus in FIG. 1.

### DETAILED DESCRIPTION OF THE EMBODIMENT

Hereinafter, exemplary embodiments of the present disclosure will be described in detail with reference to the accompanying drawings. However, in the description of the present disclosure, a description of a configuration or a function already publicly known will be omitted in order to clarify the subject matter of the present disclosure.

The terms used in the present specification are for explaining the particular embodiments, not for limiting the present disclosure. In addition, in the present specification, the singular expressions may include the plural expressions unless the context clearly dictates otherwise.

The accompanying drawings are provided only to allow those skilled in the art to understand the spirit of the present disclosure, and the scope of the present disclosure should not be interpreted as being limited by the drawings. In addition, a relative thickness, a length, and a relative size illustrated in the drawings may be exaggerated for the purpose of clarity and for convenience of description.

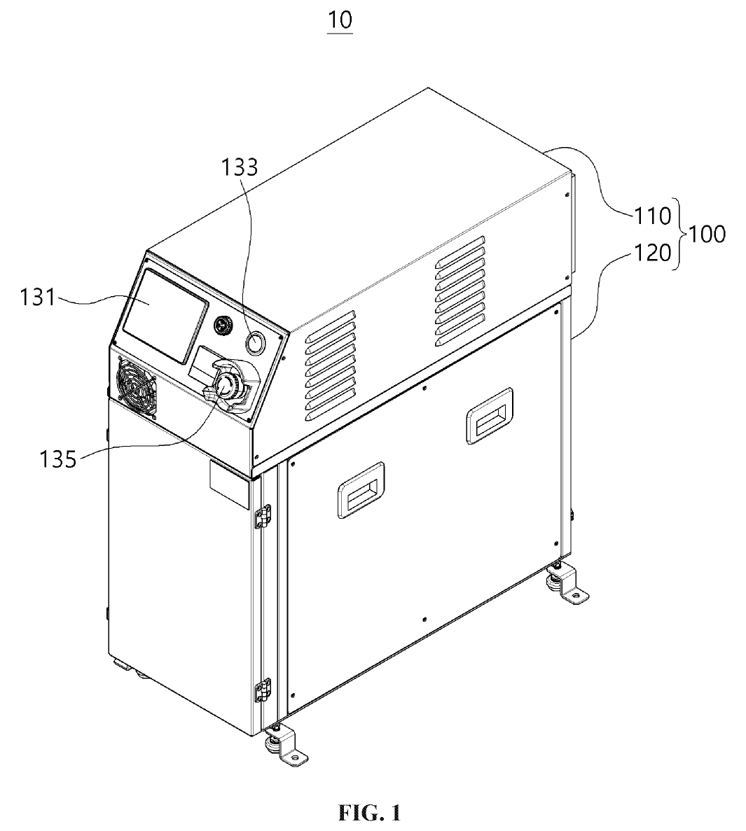

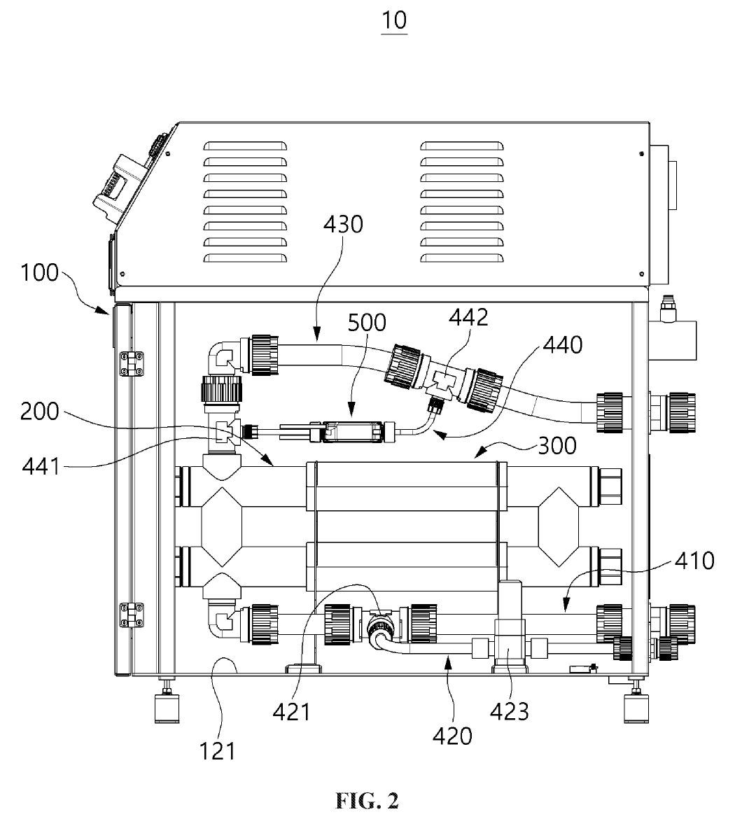

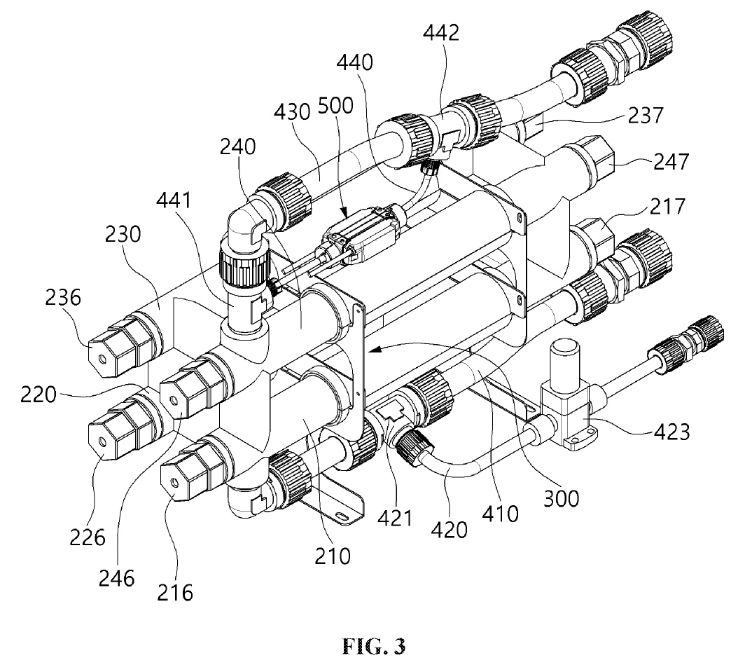

FIG. 1 is a perspective view illustrating an external appearance of an ozonated water decomposition apparatus according to an embodiment of the present disclosure, FIG. 2 is a right side view illustrating an interior of the ozonated water decomposition apparatus in FIGS. 1, and 3 is a perspective view illustrating a main configuration installed in the ozonated water decomposition apparatus in FIG. 1.

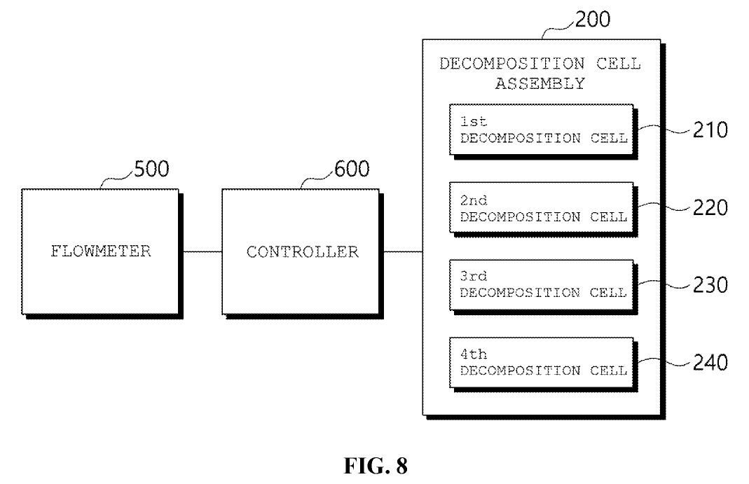

With reference to FIGS. 1 - 3, an ozonated water decomposition apparatus 10 according to the embodiment of the present disclosure includes a main body casing 100, a decomposition cell assembly 200, a decomposition cell support frame 300, an ozonated water inflow guide pipe 410, a decomposed water discharge guide pipe 430, a flow rate measurement connection pipe 440, a flowmeter 500, and a controller 600 (see FIG. 8).

The main body casing 100 defines an external appearance of the ozonated water decomposition apparatus 10 and includes an upper casing 110 and a lower casing 120. As illustrated in FIG. 2, the decomposition cell assembly 200, the decomposition cell support frame 300, the ozonated water inflow guide pipe 410, the decomposed water discharge guide pipe 430, the flow rate measurement connection pipe 440, the flowmeter 500, and the like are installed in the lower casing 120. Further, although not illustrated in FIGS. 1 and 2, various types of electrical components, which includes the controller 600 configured to control an overall operation of the ozonated water decomposition apparatus 10, an electric power supplier configured to receive electric power supplied from an external power source, convert the electric power into electric power suitable for the ozonated water decomposition apparatus 10, and stably supply the electric power, and a converter configured to operate UV lamps of the decomposition cell assembly 200, are installed in the upper casing 110.

Meanwhile, as illustrated in FIG. 1, a touch screen-type display 131, which is configured to display information related to the operation of the ozonated water decomposition apparatus 10 to provide the information to an operator or receive setting items required to operate the ozonated water decomposition apparatus 10 from the operator, is installed at a front side of the upper casing 110. In addition, as illustrated in FIG. 1, an operation indicating lamp 133 configured to indicate an operating state of the ozonated water decomposition apparatus 10 and an emergency button 135 configured to stop the operation of the ozonated water decomposition apparatus 10 in the event of an emergency situation are installed at the front side of the upper casing 110.

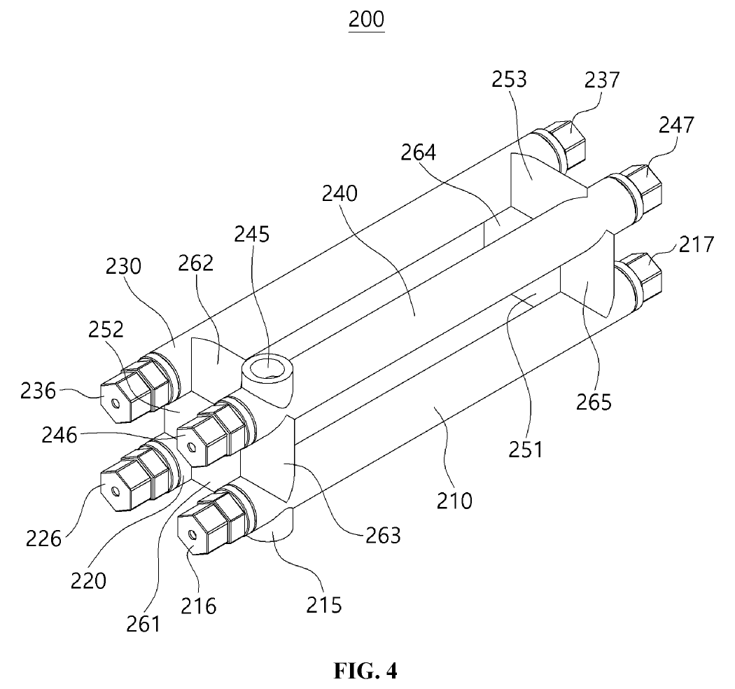

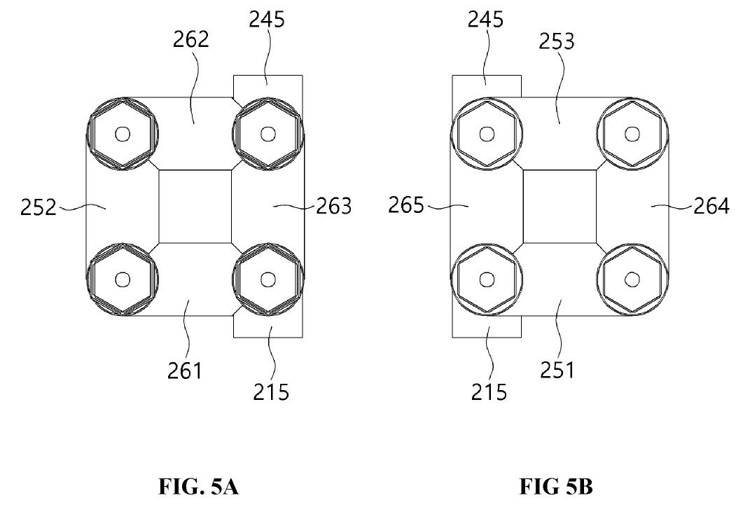

FIG. 4 is a perspective view of the decomposition cell assembly in the ozonated water decomposition apparatus in FIGS. 1, and 5A and 5B are a front view and a rear view of the decomposition cell assembly in FIG. 4.

With reference to FIGS. 2 - 5B, the decomposition cell assembly 200 is disposed in the main body casing 100 and decomposes ozonated water into water (H₂O) and oxygen (O₂) by using photolysis by irradiating the ozonated water with ultraviolet rays (UV). To this end, the decomposition cell assembly 200 includes decomposition cells 210, 220, 230, and 240 configured to decompose the ozonated water by irradiating the ozonated water with ultraviolet rays (UV). The decomposition cells 210, 220, 230, and 240 may be provided as a plurality of decomposition cells 210, 220, 230, and 240 in order to improve ozonated water decomposition performance. In the present embodiment, the decomposition cell assembly 200 includes four decomposition cells 210, 220, 230, and 240, as illustrated in FIGS. 3 and 4. Unlike the above-mentioned configuration, in the present disclosure, the decomposition cells may be provided as three or less (one, two, and three) decomposition cells or five or more decomposition cells in accordance with a size or a processing capacity of the ozonated water decomposition apparatus.

As illustrated in FIGS. 3 - 5B, the decomposition cell assembly 200 includes a first decomposition cell 210, a second decomposition cell 220, a third decomposition cell 230, a fourth decomposition cell 240, a first flow path connection pipe 251, a second flow path connection pipe 252, and a third flow path connection pipe 253. In this case, the first to fourth decomposition cells 210, 220, 230, and 240 are not simply disposed in a single row in a horizontal direction (a forward/rearward direction or a leftward/rightward direction) or a vertical direction (an upward/downward direction), but the first to fourth decomposition cells 210, 220, 230, and 240 are disposed in a 2×2 matrix structure. This is intended to implement the ozonated water decomposition apparatus 10 in a compact form by minimizing a space occupied by the four decomposition cells 210, 220, 230, and 240 within the main body casing 100 as much as possible.

The first decomposition cell 210 is disposed to be elongated in the forward/rearward direction, and the ozonated water inflow guide pipe 410 is connected to the first decomposition cell 210 in the vertical direction (upward/downward direction). An inflow connector 215, to which an end of an outlet of the ozonated water inflow guide pipe 410 is connected, is formed at a front side of the first decomposition cell 210.

The second decomposition cell 220 is disposed in parallel with the first decomposition cell 210 in the horizontal direction (leftward/rightward direction). That is, the second decomposition cell 220 is spaced apart from the first decomposition cell 210 in the horizontal direction at a predetermined interval and disposed at the same height as the first decomposition cell 210. In this case, the second decomposition cell 220 is connected to the first decomposition cell 210 through the first flow path connection pipe 251 disposed in the horizontal direction at the rear side. The first flow path connection pipe 251 provides a flow path that connects the first decomposition cell 210 and the second decomposition cell 220 so that the ozonated water flows into the second decomposition cell 220 from the first decomposition cell 210.

The third decomposition cell 230 is disposed in parallel with the second decomposition cell 220 in the vertical direction (upward/downward direction) and disposed above the second decomposition cell 220. That is, the third decomposition cell 230 is spaced apart from the second decomposition cell 220 in the vertical direction at a predetermined interval and disposed at a position higher than the second decomposition cell 220. In this case, the third decomposition cell 230 is connected to the second decomposition cell 220 through the second flow path connection pipe 252 disposed in the vertical direction at the front side. The second flow path connection pipe 252 provides a flow path that connects the second decomposition cell 220 and the third decomposition cell 230 so that the ozonated water flows into the third decomposition cell 230 from the second decomposition cell 220.

The fourth decomposition cell 240 is disposed in parallel with the third decomposition cell 230 in the horizontal direction (leftward/rightward direction), disposed in parallel with the first decomposition cell 210 in the vertical direction (upward/downward direction), and disposed above the first decomposition cell 210. That is, the fourth decomposition cell 240 is spaced apart from the third decomposition cell 230 in the horizontal direction at a predetermined interval, disposed at the same height as the third decomposition cell 230, spaced apart from the first decomposition cell 210 in the vertical direction (upward/downward direction) at a predetermined interval, and disposed at a position higher than the first decomposition cell 210. In this case, the fourth decomposition cell 240 is connected to the third decomposition cell 230 through the third flow path connection pipe 253 disposed in the horizontal direction at the rear side. The third flow path connection pipe 253 provides a flow path that connects the third decomposition cell 230 and the fourth decomposition cell 240 so that the ozonated water flows into the fourth decomposition cell 240 from the third decomposition cell 230. Further, a discharge connector 245, to which an end of an inlet of the decomposed water discharge guide pipe 430 is connected, is formed at a front side of the fourth decomposition cell 240 so that the decomposed water discharge guide pipe 430 is connected to the fourth decomposition cell 240 in the vertical direction (upward/downward direction).

Therefore, the ozonated water introduced into the decomposition cell assembly 200 through the ozonated water inflow guide pipe 410 sequentially passes through the first decomposition cell 210, the first flow path connection pipe 251, the second decomposition cell 220, the second flow path connection pipe 252, the third decomposition cell 230, the third flow path connection pipe 253, and the fourth decomposition cell 240, and decomposed water, which is water produced by decomposing ozone from the ozonated water, is discharged to the outside of the ozonated water decomposition apparatus 10 through the decomposed water discharge guide pipe 430.

In addition, as illustrated in FIGS. 3 - 5B, the decomposition cell assembly 200 further includes a first support connection pipe 261, a second support connection pipe 262, a third support connection pipe 263, a fourth support connection pipe 264, and a fifth support connection pipe 265.

The first support connection pipe 261 connects the first decomposition cell 210 and the second decomposition cell 220 in the horizontal direction at the front side, the second support connection pipe 262 connects the third decomposition cell 230 and the fourth decomposition cell 240 in the horizontal direction at the front side, and the third support connection pipe 263 connects the fourth decomposition cell 240 and the first decomposition cell 210 in the vertical direction at the front side. Further, the fourth support connection pipe 264 connects the second decomposition cell 220 and the third decomposition cell 230 in the vertical direction at the rear side, and the fifth support connection pipe 265 connects the fourth decomposition cell 240 and the first decomposition cell 210 in the vertical direction at the rear side.

The first to fifth support connection pipes 261, 262, 263, 264, and 265 are substantially identical in external appearance to the first to third flow path connection pipes 251, 252, and 253. However, the first to fifth support connection pipes 261, 262, 263, 264, and 265 serve to improve structural stability of the decomposition cell assembly 200 without providing flow paths along which the ozonated water flows. That is, the first to third support connection pipes 261, 262, and 263 are stably disposed in a structure symmetric in the upward/downward direction and the leftward/rightward direction together with the second flow path connection pipe 252 at the front side of the decomposition cell assembly 200, and the fourth and fifth support connection pipes 264 and 265 are stably disposed in a structure symmetric in the upward/downward direction and the leftward/rightward direction together with the first and third flow path connection pipes 251 and 253 at the rear side of the decomposition cell assembly 200, such that the first to fifth support connection pipes 261, 262, 263, 264, and 265 may improve the structural stability of the decomposition cell assembly 200.

Meanwhile, as illustrated in FIGS. 3 - 5B, front caps 216, 226, 236, and 246 and rear caps 217, 227, 237, and 247 are respectively coupled to two opposite ends of the first to fourth decomposition cells 210, 220, 230, and 240. Although not illustrated in the accompanying drawings, electric connectors for applying electric power required to operate the UV lamps are connected to the front caps 216, 226, 236, and 246.

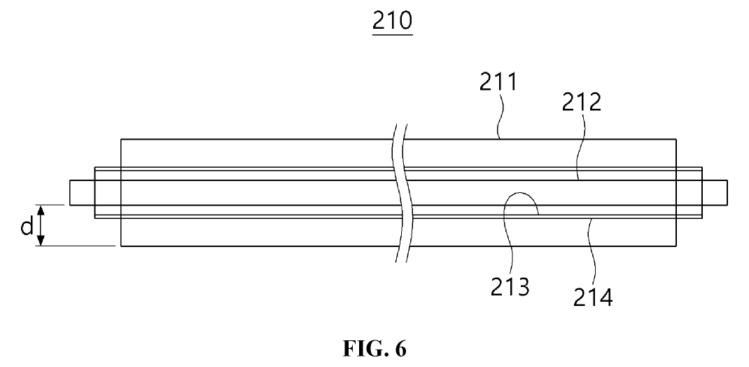

FIG. 6 is a schematic view for explaining an internal structure of the decomposition cell that constitutes the decomposition cell assembly in FIG. 4. Hereinafter, an internal structure of the first decomposition cell 210 illustrated in FIG. 6 will be described in detail. Meanwhile, because internal structures of the second decomposition cell 220, the third decomposition cell 230, and the fourth decomposition cell 240 are substantially identical to the internal structure of the first decomposition cell 210, a description thereof will be made with reference to the description of the first decomposition cell 210.

With reference to FIG. 6, the first decomposition cell 210 includes an ozonated water flow pipe 211, a UV lamp 212, a lamp protection pipe 213, and a fluorine-based ultraviolet transmission layer 214.

As illustrated in FIG. 6, the ozonated water flow pipe 211 defines an external appearance of the first decomposition cell 210 and provides a flow path in which the ozonated water flows. In this case, the ozonated water flow pipe 211 may be made of polyvinylidene fluoride (PVDF) excellent in acid resistance or chemical resistance against hydrofluoric acid (HF) or the like contained in the ozonated water. That is, the ozonated water flow pipe 211 may be provided as a PVDF pipe.

As illustrated in FIG. 6, the UV lamp 212 is disposed in the ozonated water flow pipe 211 and decomposes the ozonated water flowing along the ozonated water flow pipe 211 into water (H₂O) and oxygen (O₂) by irradiating the ozonated water with ultraviolet rays. In this case, the UV lamp 212 emits UVC ultraviolet rays having a wavelength in a range of 200 to 300 nm (e.g., 245 nm) having a high ozonated water decomposition effect. Further, in order for ultraviolet rays emitted from the UV lamp 212 to efficiently decompose the ozonated water flowing along the ozonated water flow pipe 211, a distance d between an outer peripheral surface of the UV lamp 212 and an inner peripheral surface of the ozonated water flow pipe 211 may be 10 mm or less. That is, the UV lamp 212 and the ozonated water flow pipe 211 may be configured such that the ozonated water flowing along the ozonated water flow pipe 211 is located at a distance of 10 mm or less from the UV lamp 212. Meanwhile, the UV lamp 212 is detachably mounted on the ozonated water flow pipe 211 so that the UV lamp 212 may be replaced when a service life of the UV lamp 212 ends or the UV lamp 212 fails.

As illustrated in FIG. 6, the lamp protection pipe 213 is disposed in the ozonated water flow pipe 211 and configured to accommodate the UV lamp 212. The lamp protection pipe 213 protects the UV lamp 212 by preventing the UV lamp 212 disposed in the ozonated water flow pipe 211 from coming into direct contact with the ozonated water flowing along the ozonated water flow pipe 211. In this case, the lamp protection pipe 213 is made of a material that transmits ultraviolet rays emitted from the UV lamp 212 accommodated in the lamp protection pipe 213 so that the ultraviolet rays reach the ozonated water flowing along the ozonated water flow pipe 211 outside the lamp protection pipe 213. The lamp protection pipe 213 may be made of quartz having excellent ultraviolet transmittance and low cost. That is, the lamp protection pipe 213 may be provided as a quartz pipe. Meanwhile, because the lamp protection pipe 213 is disposed in the ozonated water flow pipe 211, an outer diameter of the lamp protection pipe 213 is smaller than an inner diameter of the ozonated water flow pipe 211.

The fluorine-based ultraviolet transmission layer 214 is formed on an outer peripheral surface of the lamp protection pipe 213, which comes into contact with the ozonated water as illustrated in FIG. 6, in order to prevent the lamp protection pipe 213 from being etched by hydrofluoric acid (HF) contained in the ozonated water flowing along the ozonated water flow pipe 211. Specifically, the fluorine-based ultraviolet transmission layer 214 is formed in a thin tubular shape provided to be in contact with and attached to the outer peripheral surface of the lamp protection pipe 213 and formed to surround an entire periphery of the lamp protection pipe 213. In this case, the fluorine-based ultraviolet transmission layer 214 may be made of fluorinated ethylene propylene (FEP) having excellent acid resistance or chemical resistance against hydrofluoric acid (HF) and excellent ultraviolet transmission of 90 % or more so that ultraviolet rays emitted from the UV lamp 212 reach, with as little loss as possible, the ozonated water flowing along the ozonated water flow pipe 211.

For reference, because hydrofluoric acid (HF) is a chemical material essentially used, in a diluted state (DHF), in a semiconductor manufacturing process or a display manufacturing process (particularly, an etching process and a cleaning process), the ozonated water discarded after use in the semiconductor manufacturing process or the display manufacturing process may include hydrofluoric acid (HF).

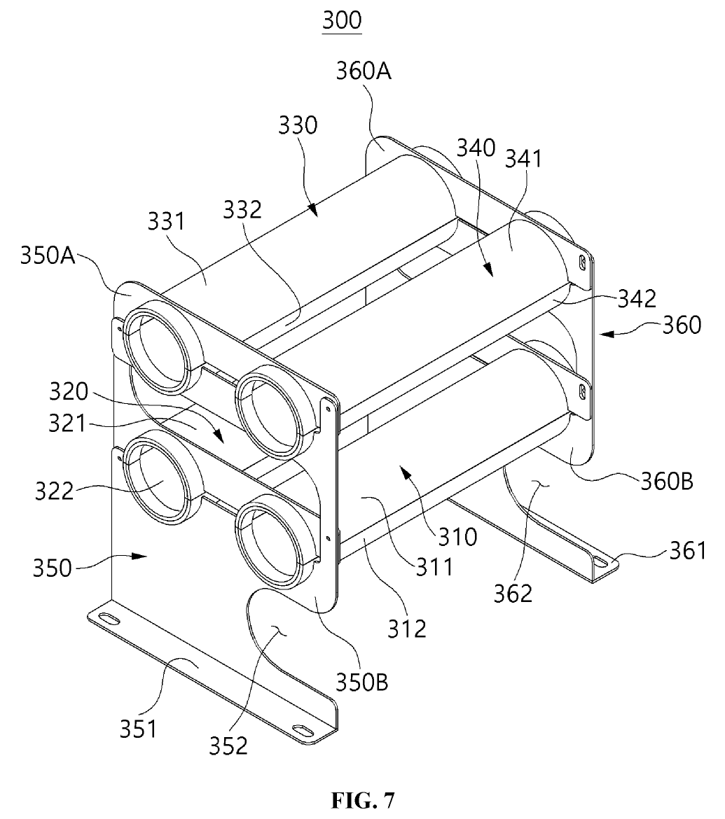

FIG. 7 is a perspective view of the decomposition cell support frame of the ozonated water decomposition apparatus in FIG. 1.

With reference to FIGS. 2, 3, and 7, the decomposition cell support frame 300 serves to support the decomposition cell assembly 200 to fix a position of the decomposition cell assembly 200 within the main body casing 100 and includes four decomposition cell support pipes 310, 320, 330, and 340, a first fixing plate 350, and a second fixing plate 360.

The four decomposition cell support pipes 310, 320, 330, and 340 are disposed at positions corresponding to the four decomposition cells 210, 220, 230, and 240 and stably support the four decomposition cells 210, 220, 230, and 240. Specifically, a first decomposition cell support pipe 310 accommodates and supports the first decomposition cell 210 in a predetermined section in a longitudinal direction of the first decomposition cell 210, a second decomposition cell support pipe 320 accommodates and supports the second decomposition cell 220 in a predetermined section in a longitudinal direction of the second decomposition cell 220, a third decomposition cell support pipe 330 accommodates and supports the third decomposition cell 230 in a predetermined section in a longitudinal direction of the third decomposition cell 230, and a fourth decomposition cell support pipe 340 accommodates and supports the fourth decomposition cell 240 in a predetermined section in a longitudinal direction of the fourth decomposition cell 240.

Meanwhile, as illustrated in FIGS. 2, 3, and 7, the first to fourth decomposition cell support pipes 310, 320, 330, and 340 include upper semicircular pipes 311, 321, 331, and 341 configured to cover upper sides of the first to fourth decomposition cells 210, 220, 230, and 240, and lower semicircular pipes 312, 322, 332, and 342 configured to cover lower sides of the first to fourth decomposition cells 210, 220, 230, and 240. Further, the upper semicircular pipes 311, 321, 331, and 341 and the lower semicircular pipes 312, 322, 332, and 342 are provided in a state in which the upper semicircular pipes 311, 321, 331, and 341 and the lower semicircular pipes 312, 322, 332, and 342 are separated from one another, and then the upper semicircular pipes 311, 321, 331, and 341 and the lower semicircular pipes 312, 322, 332, and 342 are coupled to one another during a process of assembling the decomposition cell support frame 300 to the decomposition cell assembly 200.

As illustrated in FIGS. 2, 3, and 7, the first fixing plate 350 and the second fixing plate 360 are disposed at the front side and the rear side with the first to fourth decomposition cell support pipes 310, 320, 330, and 340 interposed therebetween. Ends of the first to fourth decomposition cell support pipes 310, 320, 330, and 340 are coupled to a front side of the first fixing plate 350, and the first fixing plate 350 is fixed to a lower plate 121 of the main body casing 100 by means of a first fastening flange 351 formed at a lower end of the first fixing plate 350. Further, the other ends of the first to fourth decomposition cell support pipes 310, 320, 330, and 340 are coupled to a rear side of the second fixing plate 360, and the second fixing plate 360 is fixed to the lower plate 121 of the main body casing 100 by means of a second fastening flange 361 formed at a lower end of the second fixing plate 360. In this case, as illustrated in FIG. 7, the first and second fixing plates 350 and 360 are provided as upper portions 350A and 360A to which the upper semicircular pipes 311, 321, 331, and 341 are coupled and lower portions 350B and 360B to which the lower semicircular pipes 312, 322, 332, and 342 are coupled. The decomposition cell support frame 300 is assembled to the decomposition cell assembly 200 by fastening the upper portions 350A and 360A and the lower portions 350B and 360B.

Meanwhile, from the viewpoint of efficient space utilization within the main body casing 100, as illustrated in FIGS. 3 and 7, the first fixing plate 350 and the second fixing plate 360 are respectively formed with a first inlet space portion 352 and a second inlet space portion 362 formed at one side of lower ends thereof so that the ozonated water inflow guide pipe 410 is disposed to pass through the first inlet space portion 352 and the second inlet space portion 362.

With reference to FIGS. 2 and 3, the ozonated water inflow guide pipe 410 provides a flow path configured to guide the ozonated water, which is introduced from the outside of the ozonated water decomposition apparatus 10, to the decomposition cell assembly 200. To this end, one end (outlet side end) of the ozonated water inflow guide pipe 410 is connected to the decomposition cell assembly 200, and the other end (inlet side end) of the ozonated water inflow guide pipe 410 is exposed to the outside of the main body casing 100, such that the ozonated water inflow guide pipe 410 is connected to an ozonated water discharge line for discharging the ozonated water used in the semiconductor manufacturing process or the display manufacturing process, e.g., an ozonated water discharge line of an external apparatus, such as a semiconductor wafer cleaning apparatus. In this case, the ozonated water inflow guide pipe 410 may be made of perfluoroalkoxy (PFA) having excellent acid resistance and chemical resistance and having flexibility ensured to some extent. That is, the ozonated water inflow guide pipe 410 may be provided as a PFA pipe.

Meanwhile, as illustrated in FIGS. 2 and 3, the ozonated water decomposition apparatus 10 further includes an ozonated water discharge pipe 420 branching off from one point of the ozonated water inflow guide pipe 410. The ozonated water discharge pipe 420 provides a line through which the ozonated water remaining in the decomposition cell assembly 200 or the like is discharged to the outside of the ozonated water decomposition apparatus 10 in order to inspect or maintain the ozonated water decomposition apparatus 10. One end of the ozonated water discharge pipe 420 is connected to the ozonated water inflow guide pipe 410 through a "T"-shaped fitting 421, and the other end of the ozonated water discharge pipe 420 is exposed to the outside of the main body casing 100. Further, a valve 423 for opening or closing the flow path of the ozonated water discharge pipe 420 is installed at one point of the ozonated water discharge pipe 420.

With reference to FIGS. 2 and 3, the decomposed water discharge guide pipe 430 provides a flow path configured to guide and discharge decomposed water, from which ozone is decomposed by the decomposition cell assembly 200, to the outside of the ozonated water decomposition apparatus 10 from the decomposition cell assembly 200. To this end, one end (inlet side end) of the decomposed water discharge guide pipe 430 is connected to the decomposition cell assembly 200, and the other end (outlet side end) of the decomposed water discharge guide pipe 430 is exposed to the outside of the main body casing 100 and connected to a wastewater treatment line. In this case, like the ozonated water inflow guide pipe 410, the decomposed water discharge guide pipe 430 is made of PFA.

FIG. 8 is a block diagram schematically illustrating a control configuration of the ozonated water decomposition apparatus in FIG. 1.

With reference to FIGS. 2, 3, and 8, the flow rate measurement connection pipe 440 provides a flow path in which the flowmeter 500 is installed. The flow rate measurement connection pipe 440 connects a first point and a second point of the decomposed water discharge guide pipe 430. One end of the flow rate measurement connection pipe 440 is connected to a first point of an inlet side of the decomposed water discharge guide pipe 430 through a "T"-shaped fitting 441, and the other end of the flow rate measurement connection pipe 440 is connected to a second point closer to an outlet side of the decomposed water discharge guide pipe 430 than the first point through a "T"-shaped fitting 442. Therefore, a part of the decomposed water flowing into the decomposed water discharge guide pipe 430 from the decomposition cell assembly 200 is diverged from the first point, flows along the flow rate measurement connection pipe 440, is merged into the decomposed water flowing along the decomposed water discharge guide pipe 430 at the second point, and then is discharged to the outside of the ozonated water decomposition apparatus 10. In this case, the flow rate measurement connection pipe 440 has an inner diameter smaller in size than an inner diameter of the decomposed water discharge guide pipe 430. Particularly, the inner diameter of the flow rate measurement connection pipe 440 is 1/3 or less, more particularly 1/4 or less of the inner diameter of the decomposed water discharge guide pipe 430. Further, like the decomposed water discharge guide pipe 430, the flow rate measurement connection pipe 440 is made of PFA.

With reference to FIGS. 2, 3, and 8, in order to identify a flow rate of the decomposed water flowing along the decomposed water discharge guide pipe 430, the flowmeter 500 is installed in the flow rate measurement connection pipe 440 that provides a flow path connected to the decomposed water discharge guide pipe 430. However, unlike the present embodiment, the flowmeter 500 may be installed in the decomposed water discharge guide pipe 430. In this case, the configuration of the flow rate measurement connection pipe 440 is excluded. The flowmeter 500 may be provided as an ultrasonic flowmeter configured to measure a flow rate in a non-contact manner, and the flowmeter 500 is mounted in the flow rate measurement connection pipe 440 by clamping.

In the present embodiment, the flowmeter 500 is not installed in the decomposed water discharge guide pipe 430 and does not directly measure a flow rate of the decomposed water flowing along the decomposed water discharge guide pipe 430, but the flowmeter 500 is installed in the flow rate measurement connection pipe 440 and identifies a flow rate of the decomposed water flowing along the decomposed water discharge guide pipe 430 by measuring a flow rate of the decomposed water flowing along the flow rate measurement connection pipe 440. This is intended to solve a problem in which the non-contact-type flowmeter 500 installed in the decomposed water discharge guide pipe 430 cannot accurately measure a flow rate of the decomposed water flowing along the decomposed water discharge guide pipe 430 in case that a flow rate of the decomposed water flowing along the decomposed water discharge guide pipe 430 is low. That is, in order to accurately identify a flow rate of the decomposed water flowing along the decomposed water discharge guide pipe 430 even in case that the decomposed water passes through the decomposed water discharge guide pipe 430 at a low flow rate, the flowmeter 500 may be installed in the flow rate measurement connection pipe 440 having a smaller inner diameter than the decomposed water discharge guide pipe 430 and accurately measure a flow rate of the decomposed water flowing along the flow rate measurement connection pipe 440.

For reference, because the flow rate of the decomposed water flowing along the decomposed water discharge guide pipe 430 and the flow rate of the decomposed water along the flow rate measurement connection pipe 440 are proportional to each other, it is possible to identify the flow rate of the decomposed water flowing along the decomposed water discharge guide pipe 430 even by measuring the flow rate of the decomposed water flowing along the flow rate measurement connection pipe 440.

With reference to FIGS. 2, 3, and 8, the controller 600 controls operations of electrical components of the ozonated water decomposition apparatus 10 and processes measurement data received from various types of sensors of the ozonated water decomposition apparatus 10. In particular, the controller 600 controls the operations of the plurality of decomposition cells 210, 220, 230, and 240 based on flow rate data measured by the flowmeter 500, i.e., based on variations of the flow rates measured by the flowmeter 500. In this case, the controller 600 controls ON/OFF operations of the UV lamps in the plurality of decomposition cells 210, 220, 230, and 240.

Specifically, the controller 600 controls and operates all or some of the plurality of decomposition cells 210, 220, 230, and 240 based on flow rate data measured by the flowmeter 500. The controller 600 controls the operations of the plurality of decomposition cells 210, 220, 230, and 240 by increasing the number of decomposition cells in which the UV lamps are in an ON state among the plurality of decomposition cells 210, 220, 230, and 240 when a flow rate measured by the flowmeter 500 increases, and decreasing the number of decomposition cells in which the UV lamps are in an ON state among the plurality of decomposition cells 210, 220, 230, and 240 when a flow rate measured by the flowmeter 500 decreases.

More specifically, when a flow rate measured by the flowmeter 500 is less than a first set flow rate value, the controller 600 turns on one decomposition cell, e.g., the UV lamp of the first decomposition cell 210, among the first to fourth decomposition cells 210, 220, 230, and 240, and turns off the UV lamps of the remaining three decomposition cells. When a flow rate measured by the flowmeter 500 is equal to or more than the first set flow rate value and less than a second set flow rate value, the controller 600 turns on two decomposition cells, e.g., the UV lamps of the first and second decomposition cells 210 and 220, among the first to fourth decomposition cells 210, 220, 230, and 240, and turns off the UV lamps of the remaining two decomposition cells. When a flow rate measured by the flowmeter 500 is equal to or more than the second set flow rate value and less than a third set flow rate value, the controller 600 turns on three decomposition cells, e.g., the UV lamps of the first to third decomposition cells 210, 220, and 230, among the first to fourth decomposition cells 210, 220, 230, and 240, and turns off the UV lamp of the remaining one decomposition cell. Further, when a flow rate measured by the flowmeter 500 is equal to or larger than the third set flow rate value, the controller 600 turns on the UV lamps of all the first to fourth decomposition cells 210, 220, 230, and 240. In this case, the third set flow rate value is set to be larger than the second set flow rate value, and the second set flow rate value is set to be larger than the first set flow rate value.

Therefore, the ozonated water decomposition apparatus 10 may adjust the number of UV lamps used in the plurality of decomposition cells 210, 220, 230, and 240 in accordance with the flow rate of the decomposed water, i.e., the flow rate of the introduced ozonated water, such that there is no UV lamp that is unnecessarily turned on and operated, thereby efficiently reducing power consumption of the plurality of decomposition cells 210, 220, 230, and 240.

While the present disclosure has been described above in detail with reference to the exemplary embodiments of the present disclosure, it will be apparent to those skilled in the art that the present disclosure is not limited to the above-mentioned exemplary embodiments, and the present disclosure may be variously altered and modified without departing from the spirit and scope of the present disclosure. The changed and modified examples belong to the claims of the present disclosure.

While the present disclosure has been shown and described in connection with the exemplary embodiments, it will be apparent to those skilled in the art that modifications and variations can be made without departing from the spirit and scope of the disclosure as defined by the appended claims.

1. An ozonated water decomposition apparatus comprising:
a main body casing;
a decomposition cell assembly disposed in the main body casing and comprising a plurality of decomposition cells configured to decompose ozonated water by photolysis;
an ozonated water inflow guide pipe configured to provide a flow path configured to guide ozonated water introduced from the outside to the decomposition cell assembly; and
a decomposed water discharge guide pipe configured to provide a flow path guide and discharge decomposed water, which is produced by decomposing ozone by the decomposition cell assembly, to the outside from the decomposition cell assembly,
wherein the decomposition cell comprises:
an ozonated water flow pipe configured to provide a flow path along which the ozonated water flows;
a UV lamp disposed in the ozonated water flow pipe and configured to emit ultraviolet rays to the ozonated water flowing along the ozonated water flow pipe; and
a lamp protection pipe disposed in the ozonated water flow pipe, configured to accommodate the UV lamp, and made of a material that transmits the ultraviolet rays emitted from the UV lamp.

2. The ozonated water decomposition apparatus of claim 1, wherein the decomposition cell further comprises a fluorine-based ultraviolet transmission layer formed on an outer peripheral surface of the lamp protection pipe, which is in contact with the ozonated water, in order to prevent the lamp protection pipe from being etched by hydrofluoric acid (HF) contained in the ozonated water.

3. The ozonated water decomposition apparatus of claim 2, wherein the fluorine-based ultraviolet transmission layer is made of fluorinated ethylene propylene (FEP).

4. The ozonated water decomposition apparatus of claim 1, wherein the plurality of decomposition cells comprises:
a first decomposition cell to which the ozonated water inflow guide pipe is connected;
a second decomposition cell disposed in parallel with the first decomposition cell in a horizontal direction;
a third decomposition cell disposed in parallel with the second decomposition cell in a vertical direction and disposed above the second decomposition cell; and
a fourth decomposition cell disposed in parallel with the third decomposition cell in the horizontal direction, disposed above the first decomposition cell, and connected to the decomposed water discharge guide pipe, and
wherein the ozonated water introduced into the decomposition cell assembly through the ozonated water inflow guide pipe sequentially passes through the first decomposition cell, the second decomposition cell, the third decomposition cell, and the fourth decomposition cell, and the ozonated water is discharged to the outside through the decomposed water discharge guide pipe after ozone is decomposed from the ozonated water.

5. The ozonated water decomposition apparatus of claim 4, further comprising:
a decomposition cell support frame disposed in the main body casing and configured to support the decomposition cell assembly to fix a position of the decomposition cell assembly,
wherein the decomposition cell support frame comprises:
a first decomposition cell support pipe configured to accommodate and support the first decomposition cell in a predetermined section in a longitudinal direction of the first decomposition cell;
a second decomposition cell support pipe configured to accommodate and support the second decomposition cell in a predetermined section in a longitudinal direction of the second decomposition cell;
a third decomposition cell support pipe configured to accommodate and support the third decomposition cell in a predetermined section in a longitudinal direction of the third decomposition cell;
a fourth decomposition cell support pipe configured to accommodate and support the fourth decomposition cell in a predetermined section in a longitudinal direction of the fourth decomposition cell;
a first fixing plate to which ends of the first to fourth decomposition cell support pipes are coupled, the first fixing plate being fixed to the main body casing; and
a second fixing plate to which the other ends of the first to fourth decomposition cell support pipes are coupled, the second fixing plate being fixed to the main body casing.

6. The ozonated water decomposition apparatus of claim 1, further comprising:
a flowmeter installed in the decomposed water discharge guide pipe or installed in a flow path connected to the decomposed water discharge guide pipe in order to identify a flow rate of the decomposed water flowing along the decomposed water discharge guide pipe; and
a controller configured to control operations of the plurality of decomposition cells based on flow rate data measured by the flowmeter.

7. The ozonated water decomposition apparatus of claim 6, wherein the controller controls ON/OFF operations of the UV lamps in the plurality of decomposition cells based on flow rate data measured by the flowmeter.

8. The ozonated water decomposition apparatus of claim 7, wherein the controller increases the number of decomposition cells in which the UV lamps are in an ON state among the plurality of decomposition cells when a flow rate measured by the flowmeter increases, and
wherein the controller decreases the number of decomposition cells in which the UV lamps are in an ON state among the plurality of decomposition cells when a flow rate measured by the flowmeter decreases.

9. The ozonated water decomposition apparatus of claim 6, further comprising:
a flow rate measurement connection pipe configured to provide a flow path configured to connect a first point and a second point of the decomposed water discharge guide pipe,
wherein a part of the decomposed water flowing into the decomposed water discharge guide pipe from the decomposition cell assembly is diverged from the first point, flows along the flow rate measurement connection pipe, is merged into the decomposed water flowing along the decomposed water discharge guide pipe at the second point, and then is discharged to the outside, and
wherein the flowmeter is installed in the flow rate measurement connection pipe and measures a flow rate of the decomposed water flowing along the flow rate measurement connection pipe.

10. The ozonated water decomposition apparatus of claim 9, wherein the flow rate measurement connection pipe is formed to have an inner diameter smaller in size than an inner diameter of the decomposed water discharge guide pipe.
